(19) United States
(12) Patent Application Publication
(10) Pub. No.: US 2018/0345725 A1
(43) Pub. Date: Dec. 6, 2018

(54) TIRE AND WHEEL ASSEMBLY LIFTING DEVICE

(71) Applicant: Tealcraft, LLC, Holladay, UT (US)

(72) Inventor: David Walter Teal, Holladay, UT (US)

(73) Assignee: Tealcraft, LLC, Holladay, UT (US)

(21) Appl. No.: 15/614,128

(22) Filed: Jun. 5, 2017

(51) Int. Cl. B60B 29/00; B60B 33/00

(52) U.S. Cl. CPC B60B 29/001; B60B 33/0044

(57) ABSTRACT

The present disclosure relates generally to devices and methods which use the mechanical advantage of a lever and fulcrum along with the use of force from a user's body, foot, and leg muscles, to more ergonomically and safely install wheel assemblies on vehicles while keeping the user's back at a more ergonomic angle and allowing for both of the installer's hands to remain free for stabilizing the wheel assembly during installation. The lifting device provides a foot pedal, a lifting pad and a pivot point to position a wheel assembly on a hub and/or wheel studs.

### BACKGROUND

### Field

The present disclosure relates generally to devices and methods for lifting tire and wheel assemblies.

### Discussion of the Related Art

A combination of a tire and wheel (or rim) assembly is typically found and used in connection with all manner of vehicles, including automobiles (e.g., cars, trucks, buses, motorcycles, etc.) and trailers (boat, ATV, and other hauling trailers). These assemblies are often constructed of steel or other metal alloy rims attached to a tire and held in place on the rim by the beads of the tire pressing outward from the pressure of the air that is pumped into the tire to keep it inflated.

These wheel assemblies are typically attached to automobiles and trucks by lug nuts that tighten the assembly to wheel studs protruding through holes in the wheel. Larger tire and wheel assemblies such as those associated with cars, trucks and large trailers are not easily hoisted onto the wheel studs due to the heavy weight and awkward position an installer must take to complete this task. As such, back injuries can occur during conventional methods of installing tire and wheel assemblies.

While there are known devices to assist in lifting such wheel assemblies, most devices require mechanisms incorporating electric motors, pneumatic or hydraulic cylinders, and other complicated or expensive devices.

Thus, there is a need for improved devices and methods for lifting tire and wheel assemblies.

### SUMMARY

In general, the present disclosure includes devices and methods which use the mechanical advantage of a lever and fulcrum (pivot) along with the use of force from a user's body, foot, and leg muscles, to more ergonomically and safely install wheel assemblies on vehicles while keeping the user's back at a more ergonomic angle and allowing for both of the installer's hands to remain free for stabilizing the wheel assembly during installation. In accordance with various aspects of the present disclosure, the lifting device provides a foot pedal, a lifting pad and a pivot point to position a wheel assembly on a hub and/or wheel studs. After installation of the wheel assembly, lug nuts are secured to the wheel studs.

### BRIEF DESCRIPTION OF THE DRAWINGS

The accompanying drawings are included to provide a further understanding of the disclosure and are incorporated in and constitute a part of this specification, illustrate embodiments of the disclosure, and together with the description serve to explain the principles of the disclosure, wherein:

FIG. 1 is a top perspective view of a lifting device in accordance with the present disclosure;

FIG. 2 is a bottom perspective view of the lifting device of FIG. 1 in accordance with the present disclosure;

FIG. 3 is a side view of the lifting device of FIG. 1 in accordance with the present disclosure;

FIG. 4 is a top perspective view of another embodiment of a lifting device in accordance with the present disclosure;

FIG. 5 is a bottom perspective view of the unassembled lifting device of FIG. 4 in accordance with the present disclosure;

FIG. 6A is a side view of the lifting device of FIG. 4 in an extended position in accordance with the present disclosure;

FIG. 6B is a side view of the lifting device of FIG. 4 in an unextended position in accordance with the present disclosure;

FIG. 7 is a top perspective view of another embodiment of a lifting device in accordance with the present disclosure;

FIG. 8 is a bottom perspective view of the unassembled lifting device of FIG. 7 in accordance with the present disclosure;

FIG. 9A is a side view of the lifting device of FIG. 7 in an unextended position in accordance with the present disclosure;

FIG. 9B is a side view of the lifting device of FIG. 7 in an extended position in accordance with the present disclosure;

FIG. 10 is a top view of the lifting device of FIG. 7 in an extended position in accordance with the present disclosure;

FIG. 11A is a side view illustrating a lifting device in accordance with the present disclosure as it begins lifting a wheel assembly towards a hub and wheel studs;

FIG. 11B is a side view illustrating a lifting device in accordance with the present disclosure as it helps align a wheel assembly with a hub and wheel studs; and

FIG. 11C is a side view illustrating a lifting device in accordance with the present disclosure after lifting and placing a wheel assembly on a hub and wheel studs.

### DETAILED DESCRIPTION OF THE ILLUSTRATED EMBODIMENTS

Persons skilled in the art will readily appreciate that various aspects of the present disclosure can be realized by any number of devices, methods and systems configured to perform the intended functions. Stated differently, other devices, methods and systems can be incorporated herein to perform the intended functions. It should also be noted that the accompanying drawing figures referred to herein are not all necessarily drawn to scale, and may be exaggerated to illustrate various aspects of the present disclosure, and in that regard, the drawing figures should not be construed as limiting. Finally, although the present disclosure can be described in connection with various principles and beliefs, the present disclosure should not be bound by any specific theory.

As used herein and as mentioned above, “tire and wheel assembly,” “wheel assembly,” or simply, “assembly” refers to a combination of a tire and rim assembly that is typically found and used in connection with all manner of vehicles, including automobiles (e.g., cars, trucks, buses, motorcycles, etc.) and trailers (boat, ATV, and other hauling trailers). As noted above, such assemblies are often constructed of steel or other metal alloy rims attached to a tire and held in place on the rim by the beads of the tire pressing outward from the pressure of the air that is pumped in under pressure to keep the tire inflated. The forgoing being noted, the present disclosure should not be construed as limited to assemblies for any particular vehicle, type of tire (whether inflatable or solid), materials of construction, or means for maintaining the tire, rim or other components as an assembly or on a vehicle.

In accordance with various aspects of the present disclosure, lifting devices and methods of using the same are provided for lifting tire and wheel assemblies onto a hub and/or wheel studs for securing the wheel assemblies. The lifting devices may also provide support as wheel assemblies are removed and lowered from a hub and/or wheel studs.

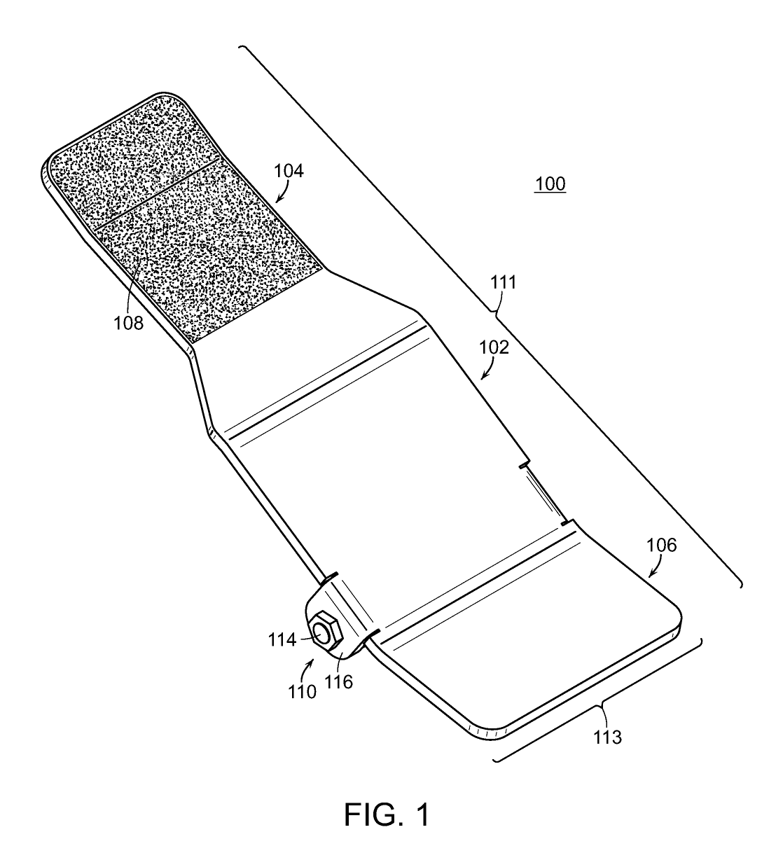

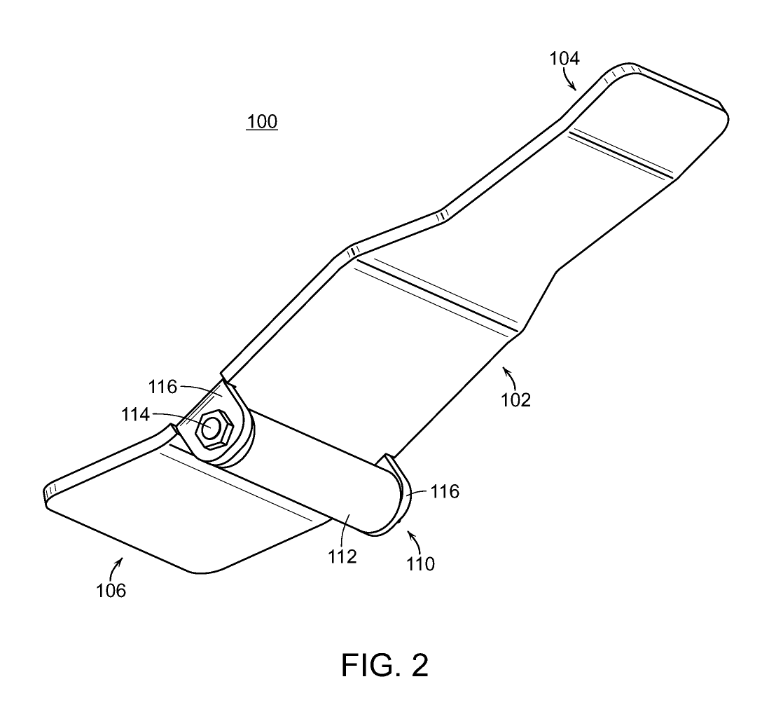

For example, with reference FIGS. 1-3 and 11A-11C, a lifting device 100 is provided for lifting tire and wheel assemblies 200 on to a hub 300 and/or wheel studs 302 for securing the assembly 200 to the hub 300. In accordance with the present disclosure, the lifting device 100 may be comprised of any number of suitably strong and rigid materials. For example, in one embodiment, all or a portion of the lifting device 100 may be comprised of 3/16 inch diamond plate steel, though other materials and thicknesses may likewise be used.

In accordance with the present disclosure, the lifting device 100 may comprise a body 102 having a foot pedal 104 and a lifting pad 106. The foot pedal 104 and lifting pad 106 may be configured at opposing ends of the body 102. The body 102, foot pedal 104, and lifting pad 106 and various combinations thereof may be distinct and separate components that are attached to one another by conventional means such as welding, brazing, or various fasteners, or may be constructed of a single, unitary piece of material.

In accordance with various aspects of the present disclosure, the foot pedal 104 and/or the lifting pad 106 may comprise surfaces with increased friction for reducing the slipping of a user's foot or the wheel assembly 200 on the lifting device 100 during operation. For example, various anti-slip friction coatings (e.g., friction tape) may be applied or adhered to the lifting device 100 in those areas. Alternatively, the surface in those locations may be etched, knurled, dimpled or otherwise mechanically “roughened” to reduce slipping.

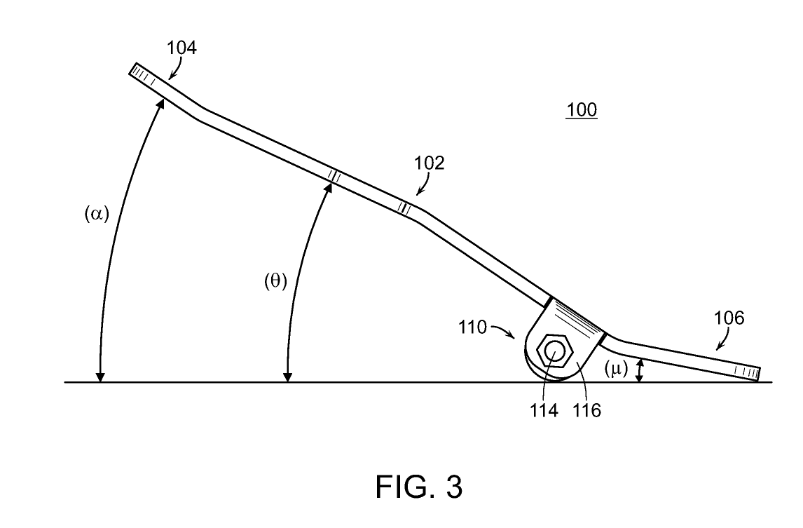

The body 102, foot pedal 104, and lifting pad 106 may be oriented with respect to one another at various angles for leverage, ergonomic, aesthetic or other reasons, based on a particular application of the lifting device 100. For example, with specific reference to FIG. 3, using the floor as a reference surface, the body 102 may be oriented at a body angle (Θ) of about 30-45°. Relative to floor and the body 102, the foot pedal 104 may be oriented at slightly steeper foot pedal angle (α). For example, if the body 102 is at a 40° angle, the foot pedal 104 may be oriented at a foot pedal angle (α) of about 45° or greater. Among other reasons, by so orienting the foot pedal 104, the foot pedal 104 and location where a user should apply force is emphasized.

With continuing reference to FIG. 3, again using the floor as a reference, the lifting pad 106 may be oriented at a lifting pad angle (μ) of about 10-15°. The smaller lifting pad angle (μ) may allow a wheel assembly 200 to be more easily loaded onto the lift pad 106. The lifting pad angle (μ) of the lift pad 106 may be varied for, among other things, to control the vertical travel of the lift pad 106 when the foot pedal 104 is depressed. The length of the lift pad 106 may be varied with the lifting pad angle (μ) to further control the vertical travel of the lift pad 106.

In accordance with various aspects of the disclosure, additional angles may be provided in the components of the lifting device 100 to provide for variance in the ergonomics, the force required to lift a wheel assembly 200, the travel of the wheel assembly 200, and the like.

In accordance with various aspects of the present disclosure, dimensions of the lifting device 100 may vary depending on specific needs and applications (e.g., the expected size of the wheel assemblies likely to be handled). For example, in accordance with one example, the overall planar shape of the lifting device 100 is generally rectangular, with a length 111 (along the longest side) of about 12 inches long and a width 113 is about 4 inches wide. However, in various embodiments, the lifting device 100 may be smaller or larger, with varying shapes, including tapers and narrower widths in central portions of the device (e.g., to reduce weight).

In accordance with various aspects of this disclosure, the foot pedal 104 is centered with the body 102 and is approximately 4 inches long by 3 inches wide. The foot pedal 104 may be secured to the body 102 by any known or as yet unknown means, such as by welding, brazing, or a variety of fasteners, though as noted above, the components of the lifting device 100, including either or both of the foot pedal 104 and the lifting pad 106, can be a single piece of material and, for example, stamped, cast, bent or otherwise manipulated into the desired form of the lifting device 100.

In accordance with various aspects of the present disclosure, the lifting device 100 may further comprise a pivot mechanism 110 that acts as a pivot between the foot pedal 104 and the lifting pad 106. Thus, by applying a force on the foot pedal 104 and moving the foot pedal 104 in a first direction, the lifting pad 106 moves in a second direction opposite the first direction. For example, pushing the foot pedal 104 towards the floor causes the lifting pad 106 to rise away from the floor. The force may be applied by a user, such as a user pressing down on the foot pedal 104 with a foot and leg or hand and arm, or the force may be provided by other mechanical means. Additionally, in accordance with various aspects of the present disclosure, handles of varying length may be attached to the lifting device 100 to provide a longer lever arm for heavier wheel assemblies 200. For example, a handle may be affixed to the lifting device 100 on the body 102 if there is no foot pedal 104 or if attachment to the body 102 is preferred, or the foot pedal 104 to extend the lever arm and reduce the force necessary to raise the wheel assembly 200.

In accordance with various aspects of the disclosure, the pivot mechanism 110 may comprise a roller 112 of a suitably strong and rigid material (e.g., steel) which keeps that portion of the body 102 away from the ground and creates a pivot point with the ground. In various embodiment, the roller 112 allows the wheel assembly 200 to be more easily rolled on the floor to a proper position for lifting the wheel assembly 200. Additionally, as noted above, the lifting pad angle (μ) as well as its length are factors in the travel of the end of the lifting pad 106 and the wheel assembly 200 upon it.

In accordance with various aspects of the present disclosure, the roller 112 is comprised of any suitably strong and rigid material. For example, various metals and alloys such as steel or aluminum, may be used. Alternatively, various polymers such as plastics and suitably rigid rubbers may be used. The size and shape may vary as well. For example, the roller 112 may comprise a continuous cylinder that is a little shorter than the width of the body 102 proximate to the roller 112. For example, the roller 112 may have a diameter of about 1.5 inches and a length of about 7.5 inches, though larger or smaller dimensions may be used depending on the particular application. With regard to the presently described roller 112, the roller 112 may be knurled about all or a portion of its length. As an alternative to the use one or more rollers, wheels, casters, and/or multiple rolling members may be used instead and still fall within the present scope.

In accordance with some aspects of the disclosure, the roller may be situated on an axle 114. The roller 112 is thus able to spin about the axle 114 allowing the lifting device 100 to be moved about on the floor more easily, particularly when carrying a wheel assembly 200. Additionally, by carrying roller 112 on an axle 114, the force required to lift a wheel assembly 200 may be reduced by virtue of the roller 112 pivoting on the axle 114.

In accordance with various aspects of the present disclosure, axle support blocks 116 may be provided for supporting the axle 114 and maintaining the roller 112 away from the body 102 a sufficient distance for clearance for roller 112 to rotate freely about the axle 114. As illustrated in FIGS. 1-3, two axle support blocks 116 are integrated with body 102 and bent orthogonally to a bottom surface of the body 102. Alternatively, the axle support blocks 116 may be separate components attached to the body 102. For example, the axle support blocks 116 may comprise tabs welded to the bottom of the lifting device 100. The axle support blocks 116 may comprise any suitable material such as 3/16 inch steel, aluminum blocks, or other materials of varying sizes, etc.

The roller 112 may be installed into mounting points in the axle support blocks 116. For example, in accordance with various aspects, the roller 112 may be held in place by pins on each end and bored into the axle support blocks 116. Alternatively, the roller 112 may be attached with machine screws 118, hex nuts, or other fasteners on each axle support block 116. In accordance with various aspects, machine screws 118 may be counter sunk and tapped into the axle support blocks 116.

As should be apparent, in addition to providing clearance for the roller 112, by lengthening axle support blocks 116, the distance a wheel assembly 200 may travel during use of the lifting device 100 may be increased. Additionally, the force required to be applied via the foot pedal 104 may be reduced, allowing heavier wheel assemblies 200 to be lifted.

In accordance with various aspects of the present disclosure, the lifting device 100 may have rollers on a top surface of the lifting pad 106 to allow the tire and wheel assembly 200 to roll and/or rotate into position, particularly when the wheel studs 302 are not lined up correctly.

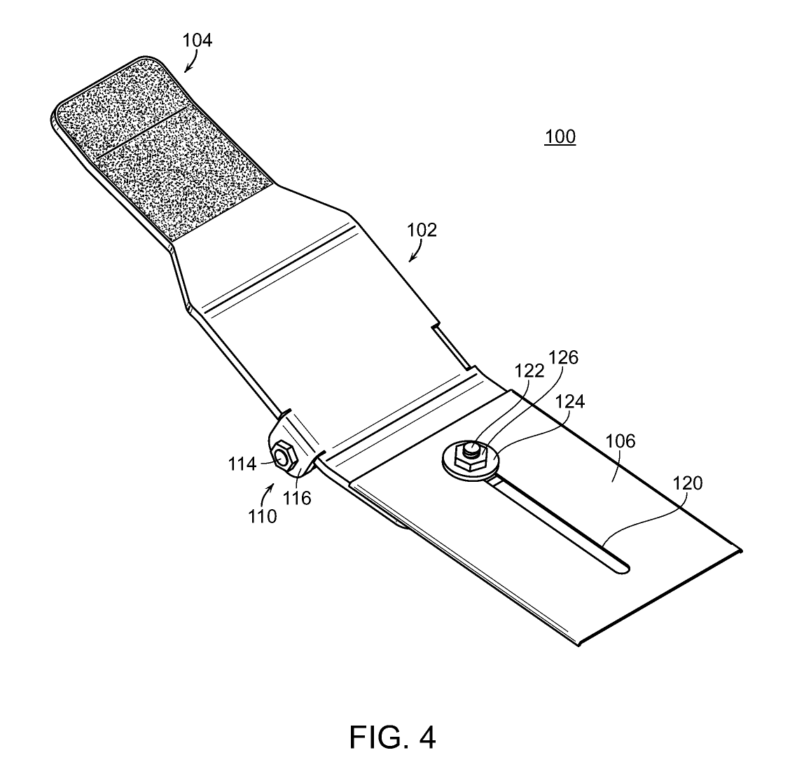

Additionally, in accordance with alternative aspects of the present disclosure, the lifting device 100 may comprise an adjustable foot pedal 104 or an adjustable lifting pad 106 that allows different angles and lever arm lengths to provide more lifting power or accommodate different size and weights of wheel assemblies 200. For example, FIGS. 4-10C illustrate examples of lifting devices with an adjustable lifting pad 106.

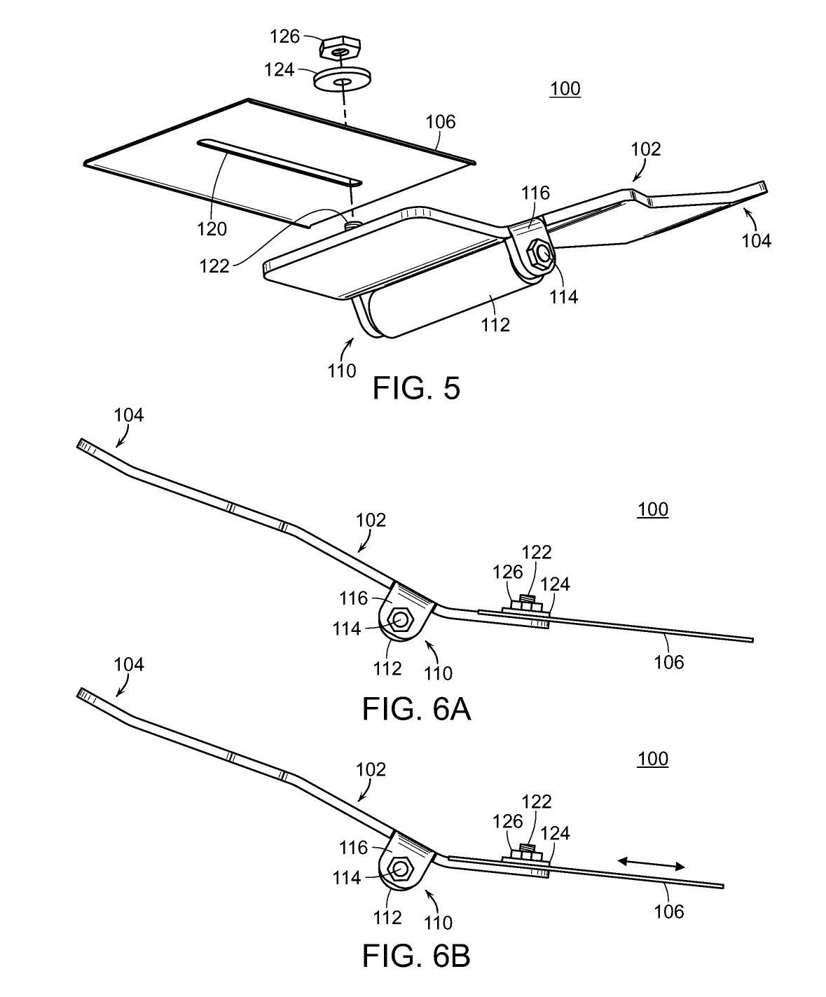

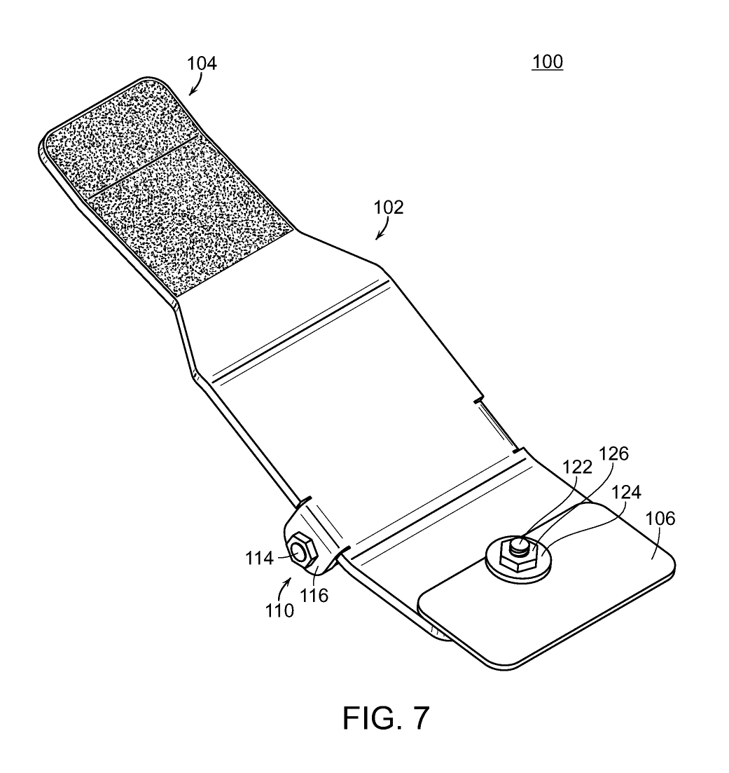

For example, FIGS. 4-6B illustrate a lifting device 100 with a lifting pad 106 that is adjustable using a slot 120 and a fastener such as a machine screw or threaded member 122, washer 124 and nut 126 combination. FIG. 5 shows the unassembled lifting device 100 of FIG. 4. As illustrated, the body 102 comprises a threaded member 122 integrate therewith. The threaded member 122 may be attached to the body 102 by welding or brazing, by screwing the threaded member 122 into a taped bore, may be a machine screw passing through a hole in the body 102, or any other conventional means of attachment. The lifting pad 106 has a slot 120 therein capable of receiving the threaded member 122 and allowing the lift pad 106 to slide along the slot 120. In the illustrated example, the slot 120 is parallel with the length of the lifting device 100, the in other embodiments it could be at an angle and/or could have various combinations of additional and/or curved slots. The washer 124 and nut 126 are attached to the threaded member 122 to maintain the lifting pad 106 in a desired position by tightening the same. For example, FIG. 6A shows the lifting pad 106 in an extended position, while FIG. 6B shows the lifting pad 106 in an unextended position.

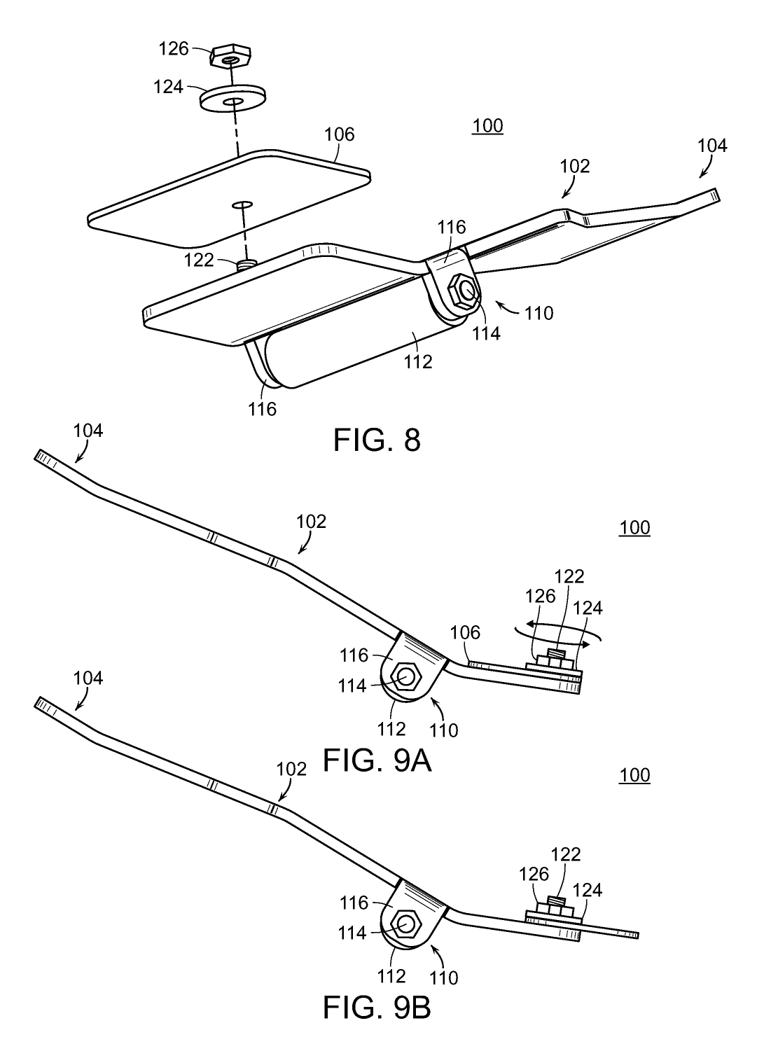

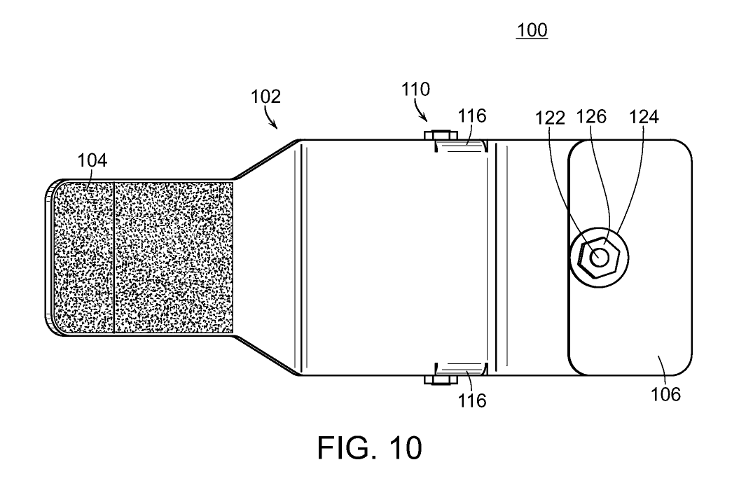

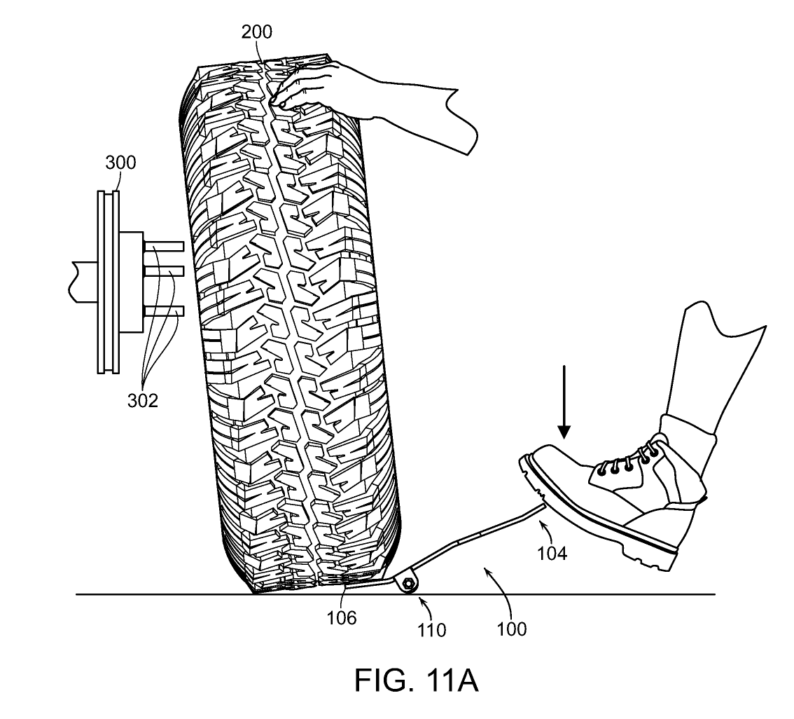

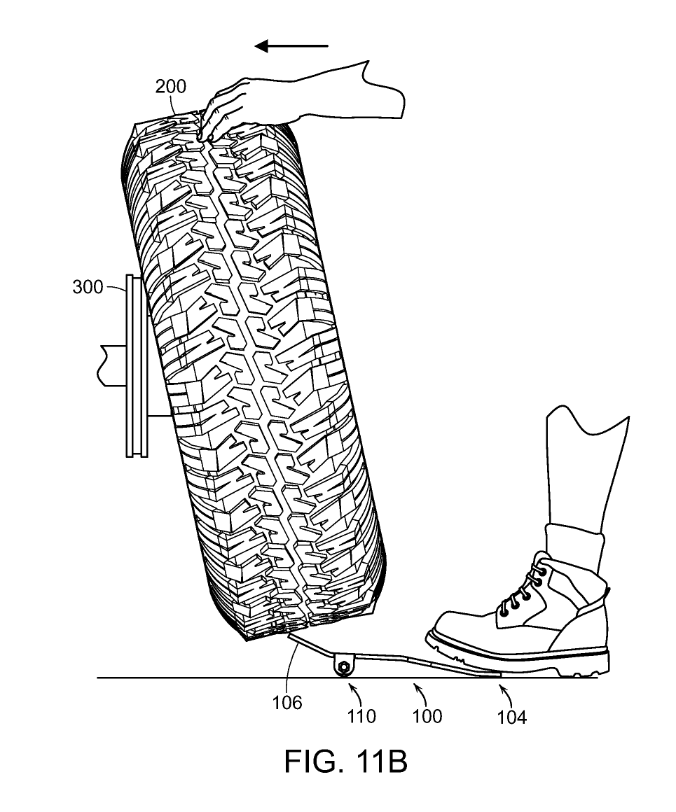

With reference now to FIGS. 7-10, another example of a lifting device 100 with a lifting pad 106 that is adjustable using a fastener such as a machine screw or threaded member 122, washer 124 and nut 126 combination. FIG. 8 shows the unassembled lifting device 100 of FIG. 7. In this example, the hole through which the threaded member 122 passes is positioned at an edge of the lifting pad 106 and as such, as the lifting pad 106 is rotated 180° about the threaded member 122, the lifting plate is unextended (FIG. 9A) or extended (FIGS. 9B and 10). The washer 124 and nut 126 are attached to the threaded member 122 to maintain the lifting pad 106 in a desired position by tightening the same.

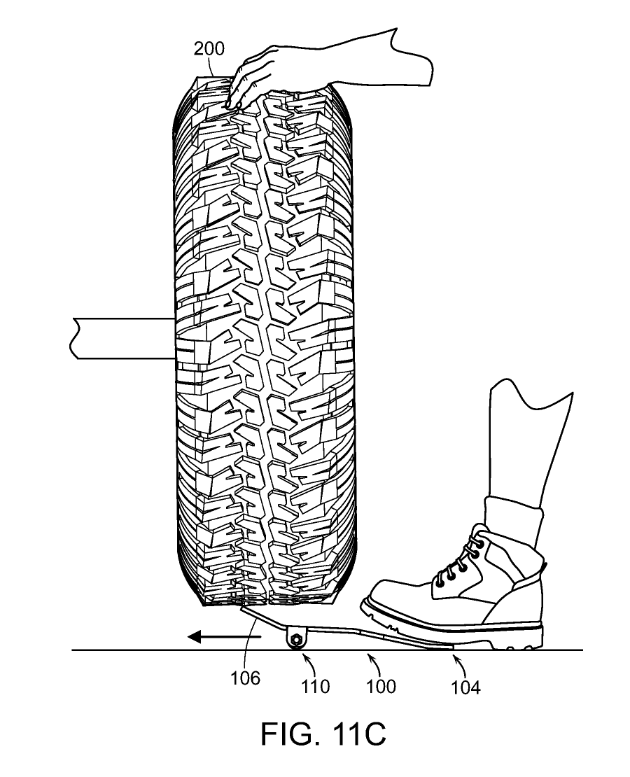

With reference now to FIGS. 11A-11C, operation of a lifting device 100 in accordance with the present disclosure is illustrated. FIG. 11A shows a wheel assembly 200 that has been positioned near a hub 300 and the wheel studs 302 to which the wheel assembly 200 is to be attached. The lifting pad 106 is positioned under the wheel assembly 200 by tilting the wheel assembly 200 and sliding the lifting pad 106 under the wheel assembly 200. Once the wheel assembly 200 has been positioned on the lifting pad 106, with reference to FIG. 11B, a user applies a downward force with the user's foot on the foot pedal 104 and the lifting device 100 translates the downward motion of the foot pedal 104 to an upward motion of the lifting pad 106 and wheel assembly 200. If necessary, prior to directing the wheel assembly 200 on to the hub 300 and wheel studs 302, the lifting device 100 and wheel assembly 200 can be moved on roller 112 to more accurately position the wheel assembly 200 with respect to the hub 300 and wheel studs 302. With reference to FIG. 11C, once in position, the lifting device 100 an wheel assembly 200 can be raised or lowered to help align the wheel assembly 200 on the hub 300 and wheel studs 302, as well as rolled towards the hub 300 and wheel studs 302 to place the wheel assembly 200. Once in position, the user can lower the lifting device 100 and remove it from under the wheel assembly 200 to complete the installation of the wheel assembly 200.

In accordance with various aspects of the present disclosure, the lifting devices and methods described may find applicability in connection with commercial uses such as in mechanic and tire shops as well as non-commercial, smaller and lighter applications such as use with regular consumer vehicles such as road-side changing of flat tires. For example, lifting devices such as those disclosed herein may be collapsible and able to fit in a car trunk or spare tire stowage area. In accordance with some aspects of the present disclosure, the lifting device may be part of a vehicle lifting jack that is standard equipment in most all vehicles. As should be appreciated, foot pedals and rollers of the device may vary in shape and size to accommodate rotating the tire and wheel assembly to line up with the wheel studs if needed and to adjust to different diameter wheel and tire assemblies.

Finally, it will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

Likewise, numerous characteristics and advantages have been set forth in the preceding description, including various alternatives together with details of the structure and function of the devices and/or methods. The disclosure is intended as illustrative only and as such is not intended to be exhaustive. It will be evident to those skilled in the art that various modifications may be made, especially in matters of structure, materials, elements, components, shape, size and arrangement of parts including combinations within the principles of the invention, to the full extent indicated by the broad, general meaning of the terms in which the appended claims are expressed. To the extent that these various modifications do not depart from the spirit and scope of the appended claims, they are intended to be encompassed therein.

We claim:

1. A lifting device for a wheel assembly comprising:
a body having a body angle (Θ) of about 30-45° relative to a floor;
a foot pedal having a foot pedal angle (α) that is steeper than the body angle (Θ);
a lifting pad having a lifting pad angle (μ) of about 10-15° relative to the floor; and
a pivot mechanism, the pivot mechanism comprising at least two support blocks having an axle and a continuous cylindrical roller that rotates about the axle, the continuous cylindrical roller extending between the support blocks.

2. The lifting device for a wheel assembly of claim 1 wherein the body, the foot pedal, the lifting pad, and the support blocks are comprised of a unitary piece of material.

3. The lifting device for a wheel assembly of claim 1 wherein at least two of the body, the foot pedal the lifting pad, and the support blocks are comprised of separate components of material attached to one another.

4. The lifting device for a wheel assembly of claim 1 wherein the lifting pad is a separate component from the body, and wherein the lifting pad further comprises a slot for receiving a threaded member.

5. The lifting device for a wheel assembly of claim 4 wherein the lifting pad may be moved laterally along the slot to extend a length of the lifting device.

6. The lifting device for a wheel assembly of claim 1 wherein the lifting pad is a separate component from the body, and wherein the lifting pad further comprises a hole for receiving a threaded member.

7. The lifting device for a wheel assembly of claim 6 wherein the lifting pad may be rotated about the hole to extend a length of the lifting device.

8. The lifting device for a wheel assembly of claim 1 wherein at least one of the foot pedal and the lifting pad have an anti-slip friction coating.

9. The lifting device for a wheel assembly of claim 1 wherein at least one of the foot pedal and the lifting pad have a roughened surface.

10. The lifting device for a wheel assembly of claim 1 wherein the body, the foot pedal, the lifting pad, and the support blocks are comprised of a metal.

11. The lifting device for a wheel assembly of claim 10 the metal is 3/16 inch diamond plate.

12. The lifting device for a wheel assembly of claim 10 wherein the continuous cylindrical roller is comprised of a metal.

13. The lifting device for a wheel assembly of claim 10 wherein the continuous cylindrical roller is comprised of a polymer.

14. The lifting device for a wheel assembly of claim 1 further comprising a handle attached to at least one of the body and the foot pedal.

15. A lifting device for a wheel assembly comprising:
a body having a body angle (Θ) of about 30-45° relative to a floor;
a foot pedal having a foot pedal angle (α) that is steeper than the body angle (Θ);
a lifting pad having a lifting pad angle (μ) of about 10-15° relative to the floor, wherein the lifting pad is a separate component from the body, and wherein the lifting pad further comprises a slot for receiving a threaded member configured so the lifting pad may be moved laterally along the slot to extend a length of the lifting device; and
a pivot mechanism, the pivot mechanism comprising at least two support blocks having an axle and a continuous cylindrical roller that rotates about the axle, the continuous cylindrical roller extending between the support blocks.

16. The lifting device for a wheel assembly of claim 15 wherein at least one of the foot pedal and the lifting pad have an anti-slip friction coating.

17. The lifting device for a wheel assembly of claim 15 wherein at least one of the foot pedal and the lifting pad have a roughened surface.

18. A lifting device for a wheel assembly comprising:
a body having a body angle (Θ) of about 30-45° relative to a floor;
a foot pedal having a foot pedal angle (α) that is steeper than the body angle (Θ);
a lifting pad having a lifting pad angle (μ) of about 10-15° relative to the floor, wherein the lifting pad is a separate component from the body, and wherein the lifting pad further comprises a hole for receiving a threaded member configured so the lifting pad may be rotated about the hole to extend a length of the lifting device; and
a pivot mechanism, the pivot mechanism comprising at least two support blocks having an axle and a continuous cylindrical roller that rotates about the axle, the continuous cylindrical roller extending between the support blocks.

19. The lifting device for a wheel assembly of claim 18 wherein at least one of the foot pedal and the lifting pad have an anti-slip friction coating.

20. The lifting device for a wheel assembly of claim 18 wherein at least one of the foot pedal and the lifting pad have a roughened surface.
